(19) United States
(12) Patent Application Publication
(10) Pub. No.: US 2007/0067300 A1
(43) Pub. Date: Mar. 22, 2007

(54) Network alarm clock communicating alarm settings over a wireless or other local area network

(76) Inventors: Jeffrey D. Ollis, Dresher, PA (US); John M. Coogan, Lansdale, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/228,181

(22) Filed: Sep. 16, 2005

(51) Int. Cl. G06F 17/30

(52) U.S. Cl. 707/10

(57) ABSTRACT

A network controller is provided. The controller includes a network interface for transmitting and receiving messages over a network between the networked controller and each of a plurality of networked devices. A first of the networked devices has a time of day event notification indicator. A processor is operatively associated with the network interface. The processor is configured to perform a method including the step of receiving a first message over the network from the first networked device. The message includes a time of day at which the event notification indicator is set. A second message is transmitted over the network to a second of the networked devices instructing the second networked device to perform a prescribed function at a desired time based on the time of day at which the event notification indictor is set. A user interface is operatively associated with the processor for adjusting user-controllable parameters.

### FIELD OF THE INVENTION

The present invention relates generally to communication networks, and more particularly to a method and apparatus for dynamically adjusting the time at which devices connected to a communication network are to perform particular functions.

### BACKGROUND OF THE INVENTION

As the Internet continues to grow and become more pervasive in homes, more and more consumer products are expected to be connected to the Internet and interconnected with one another over local area networks (LANs). For example, an Internet-equipped refrigerator can maintain an inventory of groceries and re-order when necessary. An Internet-equipped alarm clock can communicate with a source of current weather and road conditions and determine the correct time to wake up someone. Likewise, if the alarm clock is networked with a bedroom lamp, it can turn on the lamp at the appropriate time. Networked devices such as refrigerators, clocks, lamps, televisions and the like are examples of networked appliances, which may be defined as dedicated function consumer devices containing a networked processor. That is, a networked appliance is any non-general purpose device (i.e., not a PC, PDA, etc.) that has a network connection.

Other devices that ultimately may be networked together with various appliances include home control devices such security systems, sensors, and HVAC equipment, which can offer electronic control of heating, lighting and security systems.

As such devices become more and more interconnected with one another it will become more and more important for them to all be synchronized to the correct time so that they can perform specific functions at a particular time every day. For example, HVAC settings may need adjusting so that the home is warm when the residents awake. Likewise, coffee makers can be programmed to make coffee at a preset time. These are quite common requirements that can already by achieved by stand-alone or centrally-controlled programmable devices. For example, programmable thermostats that can adjust the temperature at different times of the day are quite common. Under normal circumstances the operation of these devices is quite satisfactory. However, if the schedule of the resident or other user changes, the devices do not dynamically respond to the change. For instance, if the resident needs to get up early one day to take an early flight, the HVAC and coffee maker settings will need to be adjusted to accommodate the resident's earlier schedule.

### BRIEF DESCRIPTION OF THE DRAWINGS

FIG. 1 shows the topology of a wireless communications network.

FIG. 2 shows the protocol stack in accordance with the standard Open System's Interconnection reference model for the ZigBee standard.

FIG. 3 shows an illustrative ZigBee-enabled network device.

FIG. 4 is a protocol flow, which shows the messages that are exchanged over the communications network when a networked device is instructed to perform a certain function based on the time at which a networked alarm clock's alarm is set.

FIG. 5 shows a block diagram of an illustrative network controller.

FIG. 6 shows a block diagram of an illustrative alarm clock that may be networked in accordance with the present invention.

FIG. 7 shows a block diagram of an illustrative networked device such as a networked appliance.

FIG. 8 is a flowchart showing one example of the manner in which the networked alarm clock can be used to control the time at which another networked device performs its function.

### DETAILED DESCRIPTION

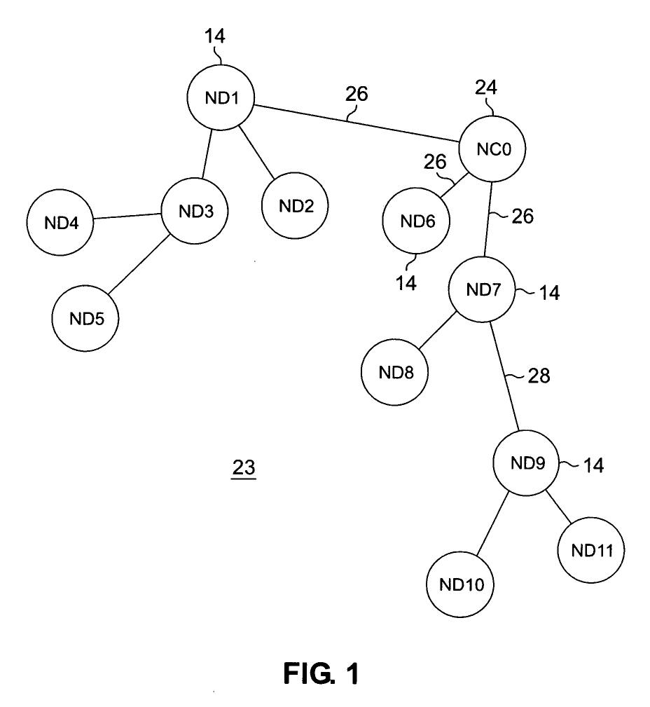

FIG. 1 shows the topology of a wireless communications network wherein a network controller (NC) controls one or more network devices (NDs), which may be connected directly to the NC or indirectly to the NC via one or more NDs. As shown, wireless communications network 23 includes a single NC 24 and eleven NDs (ND1-ND11) 14. The network controller NC is a communicating device that operates as the central controller that maintains overall network knowledge in the communications network. Likewise, the network devices ND are any communicating device (e.g., a portable communicating device or a fixed communicating device such as switches, motion sensors, temperature sensors, and networked appliances), which participates in the communication network, but which is not a central controller.

In the particular topology depicted in FIG. 1, three one-hop NDs (ND1, ND6 and ND7) 14 are directly connected to the NC 24 by node links 26. Other NDs 14 (such as ND9) are indirectly connected to the NC 24 through one or more node links, such as link 28, which directly or indirectly connect to one of the three one-hop NDs 14 (such as ND7). Although eleven NDs are shown in this particular embodiment, more generally the present invention encompasses networks in which one or more fixed or mobile NDs are employed. Also, although wireless networks are disclosed, the invention is also applicable to “wired” networks.

The wireless network 23 may conform to any of a variety of communication standards such as, without limitation, IEEE 802.11 (e.g., 802.11a; 802.11b; 802.11g), IEEE 802.15 (e.g., 802.15.1; 802.15.3, 802.15.4), DECT, PWT, pager, PCS, Wi-Fi, Bluetooth™, cellular, and the like.

Another network protocol that may be employed is ZigBee, which is a software layer based on the IEEE standard 802.15.4. Unlike the IEEE 802.11 and Bluetooth standards, ZigBee offers long battery life (measured in months or even years), high reliability, small size, automatic or semi-automatic installation, and low cost. With a relatively low data rate, 802.15.4 compliant devices are expected to be targeted to such cost-sensitive, low data rate markets as industrial sensors, commercial metering, consumer electronics, toys and games, and home automation and security. For many of these applications, other communications standards have been found to be prohibitively expensive, thereby preventing their widespread use.

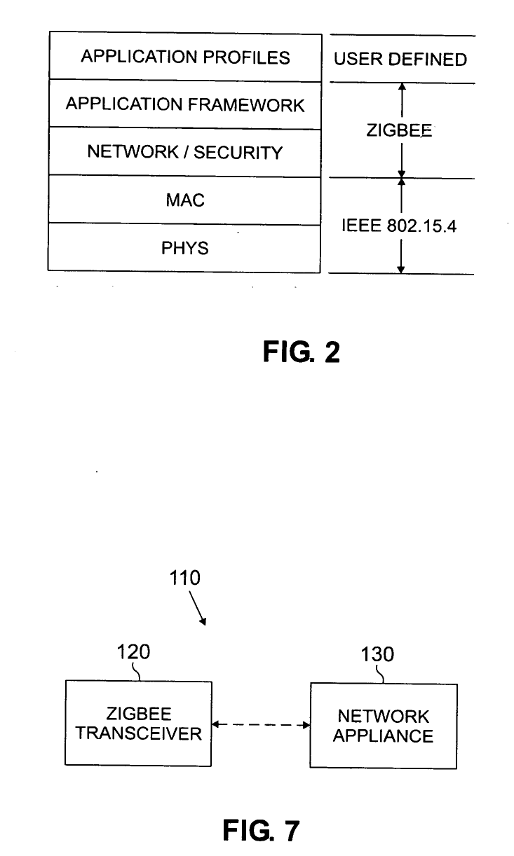

Following the standard Open System's Interconnection reference model, ZigBee's protocol stack is structured in layers. As shown in FIG. 2, the first two layers, physical (PHY) and media access (MAC), are defined by the IEEE 802.15.4 standard. The layers above them are defined by the ZigBee alliance.

ZigBee-compliant products operate in unlicensed bands worldwide, including 2.4 GHz (global), 902 to 928 MHz (Americas), and 868 MHz (Europe). Raw data throughput rates of 250 Kbps can be achieved at 2.4 GHz (16 channels), 40 Kbps at 915 MHz (10 channels), and 20 Kbps at 868 MHz (1 channel). The transmission distance generally ranges from 10 to 75 m, depending on power output and environmental characteristics. Like Wi-Fi, Zigbee uses direct-sequence spread spectrum in the 2.4 GHz band, with offset-quadrature phase-shift keying modulation. Channel width is 2 MHz with a 5 MHz channel spacing. The 868 and 900 MHz bands also use direct-sequence spread spectrum but with binary-phase-shift keying modulation.

The IEEE 802.15.4 specification defines four basic frame types: data, acknowledgement (ACK), MAC command and beacon. The data frame provides payloads of up to 104 bytes. The ACK frame provides feedback from the receiver to the sender confirming that the packet was received without error. The MAC command frame provides the mechanism for remote control and configuration of the network devices. The centralized network controller uses MAC to configure individual network device's command frames no matter how large the network. Finally, the beacon frame wakes up client devices, which listen for their address and go back to sleep if they don't receive it.

ZigBee networks can use beacon or non-beacon environments. Beacons are used to synchronize the network devices, identify the network, and describe the structure of the superframe. The beacon intervals are set by the network controller and can vary from 15 ms to over 4 minutes. Sixteen equal time slots are allocated between beacons for message delivery. The channel access in each time slot is contention-based. However, the network coordinator can dedicate up to seven guaranteed time slots for noncontention based or low-latency delivery.

The non-beacon mode is a simple, traditional multiple-access system of the type used in simple peer and near-peer networks. It operates like a two-way radio network, where each device is autonomous and can initiate a conversation at will, but could interfere with others unintentionally. The recipient may not hear the call or the channel might already be in use. Beacon mode is a mechanism for controlling power consumption in extended networks such as cluster tree or mesh. It enables all the devices to know when to communicate with each other. In ZigBee, the two-way radio network has a central dispatcher that manages the channel and arranges the calls. A primary value of beacon mode is that it reduces the system's power consumption.

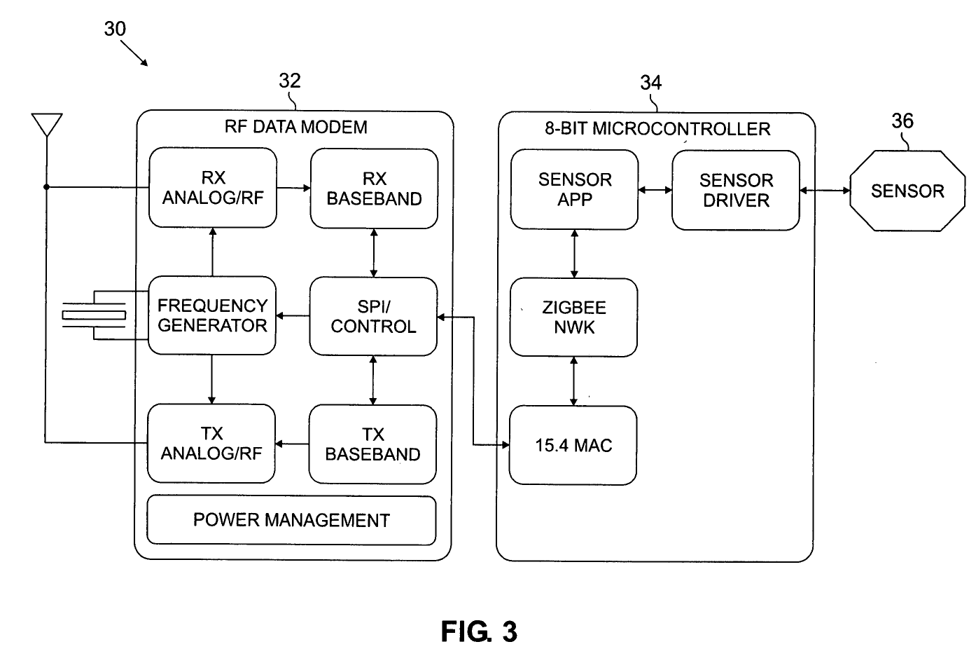

As FIG. 3 shows, an illustrative ZigBee-enabled network device 30 includes an analog portion 32 (e.g., a radio frequency integrated circuit) that has a partially implemented PHY layer. The analog portion is connected to a digital portion 34 (e.g., a low-power, low-voltage 8-bit microcontroller) with peripherals, which in turn is connected to an application sensor or actuator 36. The protocol stack and application firmware generally reside in a memory such an on-chip flash memory. The analog part of the receiver converts the desired signal from RF to the digital baseband. Synchonization, despreading and demodulation are performed in the digital part of the receiver. The digital part of the transmitter does the spreading and baseband filtering, whereas the analog part of the transmitter does the modulation and conversion to RF. ZigBee enabled transceivers of the type depicted in FIG. 3 are commercially available from a number of vendors, including, for example, Motorola.

As previously mentioned, networked devices are sometimes required to perform specific functions at a particular time every day. Normally, these times are based on the schedule of the resident and will be pre-established and programmed into the devices. However, if the schedule of the resident or other user changes, the devices do not dynamically respond to the change. For instance, using the aforementioned example, if the resident needs to get up early one day to take an early flight, the HVAC and coffee maker settings will need to be adjusted to accommodate the resident's earlier schedule.

The present inventors have recognized that there is one device in the home that the resident often adjusts in accordance with changes to his or her schedule an alarm clock. For instance, if the resident needs to get up early one day, an alarm clock will usually be set to the earlier time at which the resident wishes to awake. Accordingly, in an alarm clock (or, more generally, any clock that has as event notification indicator of some sort) is network equipped so that it becomes another network device. In this way any changes to the clock's alarm settings can be communicated to the network controller over the wireless network. The network controller, in turn, can adjust the time at which other network devices (e.g., HVAC equipment, coffee makers, ovens, lights, television and stereo units, media centers, and security sensors such as motion detectors) are scheduled to perform their particular functions. In this way the network devices can dynamically respond to changes in the resident's schedule.

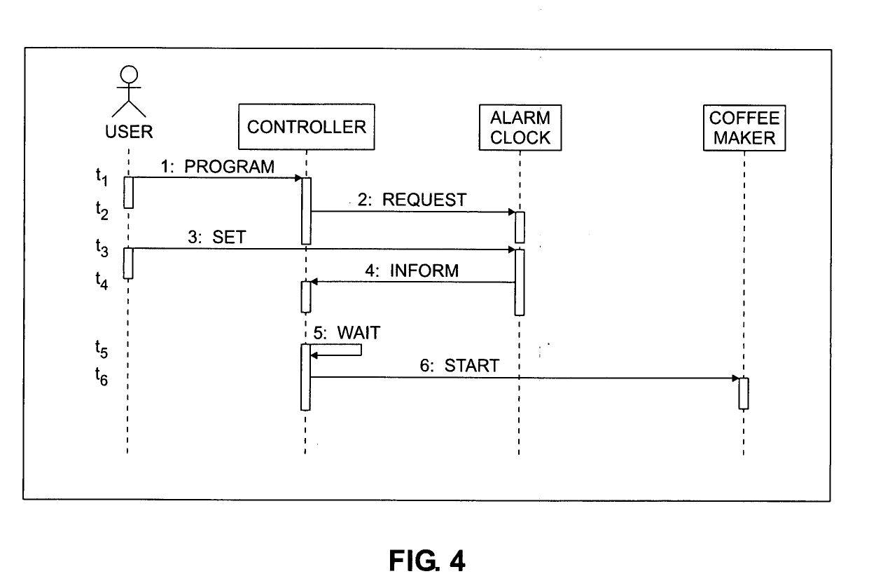

FIG. 4 is a protocol flow that shows the messages that are exchanged over the communications network 23 when a networked device is instructed to perform a certain function based on the time at which a networked alarm clock's alarm is set. For purposes of illustration only the networked device that is to be controlled is a coffee maker that is to be programmed so that it begins making coffee a predetermined amount of time (e.g., 0 or 15 minutes) before the alarm is set to go off. In a ZigBee compliant network, these messages generally will be embodied data frames. The method begins at time t1 when the user instructs or programs the network controller that the coffee maker should begin making coffee 15 minutes before the alarm goes off. At time t2 the controller sends a message over the network to the alarm clock instructing the alarm clock to inform the controller whenever its alarm is set. At time t3 the user sets the alarm clock to go off at say, 6:30 am. At time t4 the alarm clock transmits a message to the network controller that the alarm is set for 6:30 am. At time t5 the controller waits until the time at which the alarm clock is set (e.g., 6:30 am). Finally, at 6:30 am (time t6 in the protocol flow of FIG. 4) the network controller sends a message instructing the coffee maker to begin making coffee. That is, the network controller sends the message at the time the coffee maker is to begin making coffee. Alternatively, if the coffee maker can be preprogrammed, the network controller may send the message in advance (e.g., at time t5) to thereby preprogram the coffee maker to make coffee.

In one alternative embodiment, instead of the controller sending a message at time t2 over the network instructing the alarm clock to inform the controller whenever its alarm is set, the alarm clock may simply send a message whenever there is a change in its status (i.e., the alarm time is changed or the alarm is turned on or off). That is, the controller assumes there has been no change in the alarm clock's status unless and until it receives a message from the alarm clock saying otherwise. Upon receipt of such a message from the alarm clock, the controller, in turn, may send a message to the coffee maker requesting it to adjust the time as which the coffee is to be made (assuming that the controller instructs the coffee maker in advance of when it is to begin making coffee) This message may instruct the coffee maker to adjust the time by overriding the previous instruction (e.g., “begin making coffee at 5:30 am”). Alternatively, the message may instruct the coffee make to adjust the time by sending a message such as “begin making coffee an hour earlier.” Viewed differently, the content of the messages that are transmitted depend in part on which device (the alarm clock, the controller or the coffee maker) is used to monitor the current time.

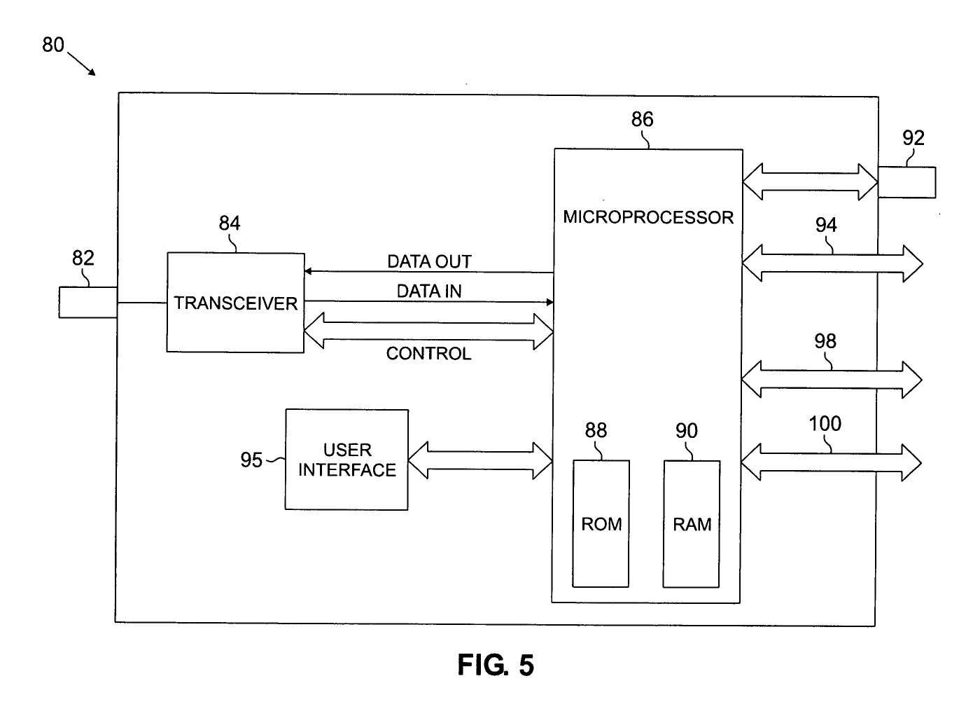

FIG. 5 shows a block diagram of an illustrative network controller 80 (e.g., network controller 24 in FIG. 1) that may be employed in the present invention. The network controller 80 includes an antenna port 82, RF front-end transceiver 84, microprocessor 86 having ROM 88 and RAM 90, programming port 92, and sensor bus 94. If the network controller is ZigBee compliant, front end transceiver may be of the type depicted in FIG. 3 by analog portion 32 and digital portion 34. If employed, sensor bus 94 may include, for example, one or more analog-to-digital inputs, one or more digital-to-analog outputs, one or more UART ports, one or more Serial Peripheral Interface (SPI) and/or one or more digital I/O lines (not shown). The network controller may also include RAM port 98 and ROM port 100 for, among other things, upgrading software residing in the microprocessor 86. User interface 95 (e.g., a keypad) allows control of the various user-adjustable parameters of the network controller 80.

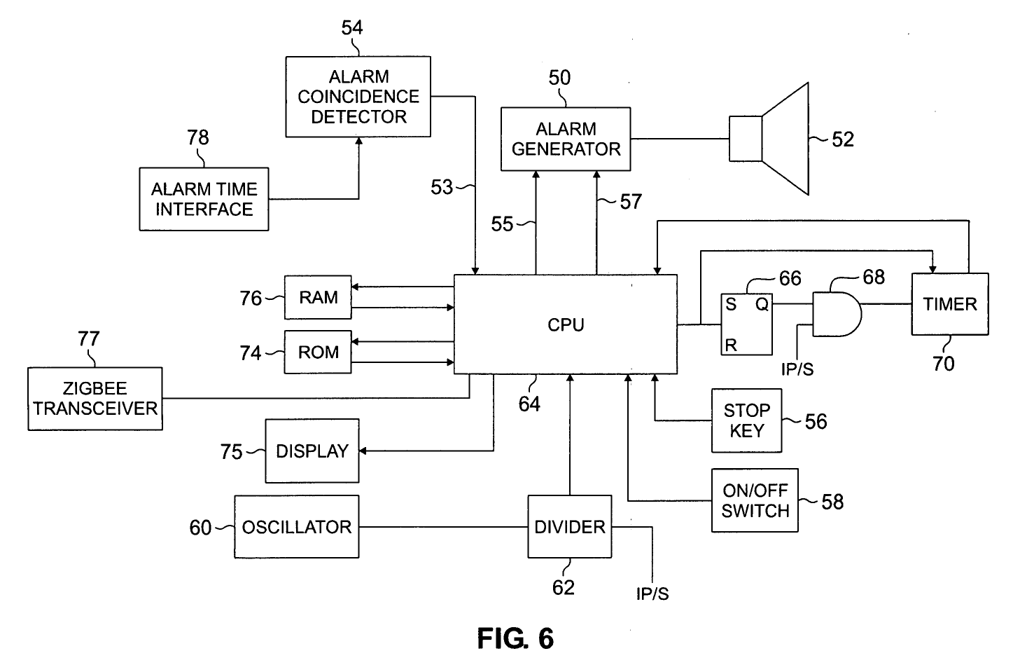

FIG. 6 shows a block diagram of an illustrative networked alarm clock that may be networked in the manner discussed above. Of course, the alarm clock is not limited to having the particular functionality depicted herein. Moreover, the functionality of the networked alarm clock may be only one part of a networked device that provides functionality in addition to the determination and presentation of time-related data. For instance, the alarm clock may be incorporated in a networked television, media center, appliance or the like. While the device shown in FIG. 6 is presented for illustrative purposes in terms of a clock that has an audible alarm (i.e., an alarm clock), the functionality of the alarm more generally may be replaced by, or supplemented with, any type of event notification indicator such as a visual indicator (e.g., room lights, LED lamp), music, television or other video broadcasts, and the like. As shown, a high frequency signal generated by an oscillator 60 is divided by a frequency divider 62 to provide a clock signal that counts the current time and calendar information, which becomes the standard of the operation of a CPU 64 and also provides a time recording signal of 1 Hz for time recording/measuring purposes. The clock signal is output and delivered to CPU 64, and the timing signal of 1 Hz is delivered to an AND gate 68. An alarm time interface 78 allows the user to set the alarm time. An alarm coincidence detector 54 monitors the alarm time set in the alarm time interface 78 and outputs a coincidence detection signal 53 to CPU 64 when the current time coincides with the alarm time. When CPU 64 receives the alarm coincidence detection signal 53 from the alarm coincidence detector 54, CPU 64 outputs a signal 55 to an alarm sound generator 50 (or, more generally, any desired event notification indicator)to generate an alarm signal to thereby cause a speaker 52 to output the alarm. When CPU 64 receives the alarm coincidence detection signal 53, it sets a flip-flop 66 and starts up the timer 70. When flip-flop 66 is set, a 1 Hz signal applied to one input of AND gate 68 is inputted to an input of the timer 70 via AND gate 68. The timer 70 counts 1-Hz signals to measure a time lapse from the starting of sounding the alarm, and outputs information on the measured time to CPU 64. When a predetermined time (e.g., one minute) elapses from the start of sounding the alarm, CPU 64 outputs an alarm stop signal 57 to the alarm sound generator 50 and stops sounding the alarm. Additional user interfaces such as from a stop key 56 and alarm on/off switch 58 also provide detection signals to CPU 64. A display 75 shows the current time, the alarm time, and possibly additional information such as calendar information. A ZigBee transceiver 77 such as depicted in FIG. 3 by analog portion 32 and digital portion 34 is also in communication with the CPU 64 to enable the alarm clock to communicate over the network (e.g., to transmit to the controller the time at which the alarm is set).

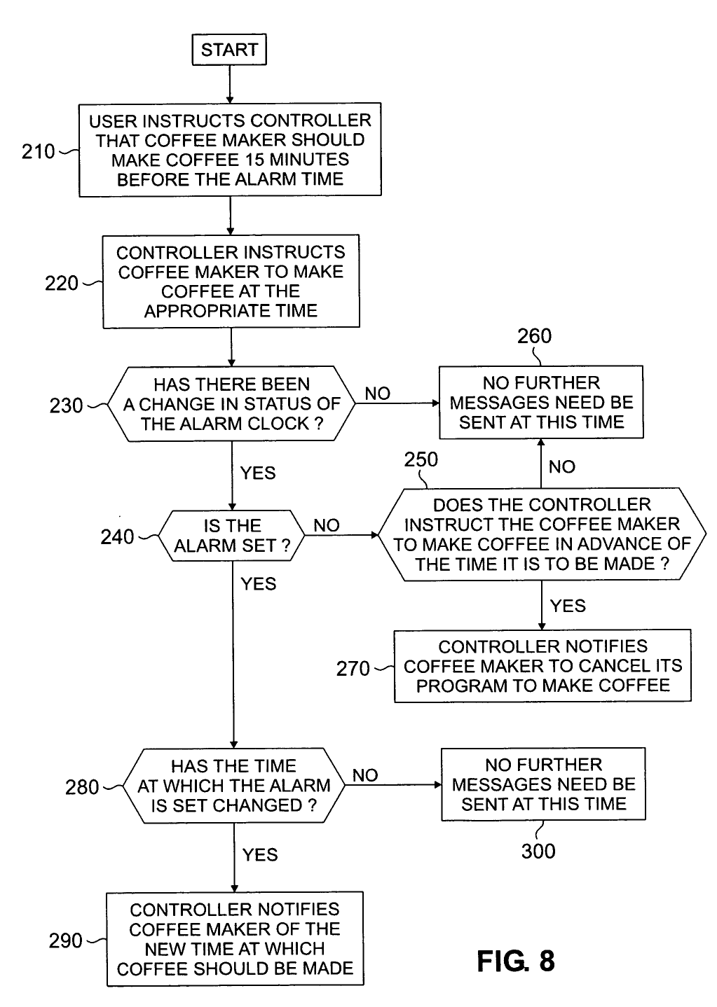

FIG. 7 shows a block diagram of an illustrative networked device such as a networked appliance (e.g. a coffee maker) that may controlled under the direction of the controller in the aforementioned manner alarm. Networked device 110 includes Zigbee transceiver 120 and network appliance 130.

It will be understood that the particular functional elements set forth in the figures above are shown for purposes of clarity only and do not necessarily correspond to discrete physical elements. Moreover, the various functional elements may be performed in hardware, software, firmware, or any combination thereof. For example, various of the functional elements of the alarm clock depicted in FIG. 6 may all be located in a single IC clock module.

FIG. 8 is a flowchart showing one example of the manner in which the networked alarm clock can be used to control the time at which another networked device performs its function. Continuing with the previous example, the networked device will be referred to as a networked coffee maker. The process begins at step 210 when the user instructs the controller that the coffee maker should make coffee at a predetermined time that is based on the time at which the alarm is set (e.g., 15 minutes before or after the alarm is set to go off). In step 220 the controller instructs the coffee maker to make coffee at the predetermined time. This step may be performed in advance by sending a message to program the coffee maker or it may be performed at the time coffee is to be made. Next, a determination is made at step 230 as to whether there has been a change in the status of the alarm clock since the prior instructions were communicated to the coffee maker. If no, then the controller does not need to send any additional messages to the coffee maker at this time (step 260). If yes, then another determination is made at step 240 as to whether the-alarm is currently set. If no, then the process continues at step 250 where a determination is made as to whether or not the coffee maker is programmed in advance. If the controller instructs the coffee maker to make coffee in advance, then at step 270 the controller notifies the coffee maker to cancel its program to make coffee. If, on the other hand, the controller instructs the coffee maker to make coffee only at the time coffee is to be made, then no additional messages need to be sent by the controller at this point (step 260).

Returning to step 240, if the alarm is set, then at step 280 a determination is made whether or not the time at which the alarm is set has changed from its previous time. If yes, the controller notifies the coffee maker at step 290 of the new time at which coffee should be made. If no, then no additional messages need be sent to the coffee maker at this time (step 300).

1. At least one computer-readable medium encoded with instructions which, when executed by a processor, perform a method including the steps of:
receiving a first message over a communications network from a first networked device having an clock with an event notification indicator, said message including a time of day at which the event notification indicator is set; and
transmitting a second message over the communications network to a second networked device instructing the second networked device to perform a prescribed function at a desired time based on the time of day at which the event notification indicator is set.

2. The computer-readable medium of claim 1 wherein the second message is transmitted at the time of day at which the second networked device is to perform the prescribed function.

3. The computer-readable medium of claim 1 wherein the second message is transmitted in advance of the time of day at which the second networked device is to perform the prescribed function so that the second networked device is preprogrammed to perform the prescribed function.

4. The computer-readable medium of claim 1 further comprising the step of transmitting a third message to the second networked device to adjust the time of day at which the second networked device is to perform the prescribed function when a change is made to the time of day at which the event notification indicator is set.

5. The computer-readable medium of claim 1 further comprising the step of transmitting a preliminary message to the first networked device requesting it to transmit a message when its event notification indicator is set, said preliminary message including the time of day at which the event notification indicator is set.

6. The computer-readable medium of claim 1 further comprising the step of receiving a preliminary message from the first networked device indicating a change in status of the first networked device.

7. The computer-readable medium of claim 1 wherein the communication network is a wireless network compliant with a ZigBee protocol.

8. The computer-readable medium of claim 1 wherein the second networked device is a networked appliance.

9. The computer-readable medium of claim 8 wherein the networked appliance is a coffee maker.

10. The computer-readable medium of claim 1 wherein the second networked device is a residential control device.

11. A network controller, comprising:
a network interface for transmitting and receiving messages over a network between the networked controller and each of a plurality of networked devices, a first of the networked devices having a time of day event notification indicator;
a processor operatively associated with the network interface, said processor being configured to perform a method including the steps of:
receiving a first message over the network from the first networked device, said message including a time of day at which the event notification indicator is set; and
transmitting a second message over the network to a second of the networked devices instructing the second networked device to perform a prescribed function at a desired time based on the time of day at which the event notification indictor is set; and
a user interface operatively associated with the processor for adjusting user-controllable parameters.

12. The network controller of claim 11 wherein the network interface comprises a wireless transceiver.

13. The network controller of claim 12 wherein said wireless transceiver is ZigBee complaint.

14. A networked device, comprising
a network interface for transmitting and receiving messages over a network to and from a networked controller;
a user interface for establishment of a time of an event;
a processor coupled to the user interface and the network interface, the processor generating a message that includes the time of the event so that the message is transmitted by the network interface over the network to the networked controller.

15. The networked device of claim 14 wherein the processor is configured to generate the message at the time of the event

16. The networked device of claim 14 wherein the processor is configured to generate the message upon receipt of a message from the networked controller requesting the time of the event.

17. The networked device of claim 14 further comprising:
a source of clock pulses, wherein the user interface is further configured for establishing a time of day in addition to the time of the event, said processor being further configured to receive the clock pulses from the source and generate a current time based on the time of day and the clock pulses.

18. A networked device, comprising
a network interface for receiving messages over a network from a networked controller;
at least one actuator for performing a prescribed function; and
a processor coupled to the actuator and the network interface, said processor causing the actuator to perform the prescribed function at a prescribed time in response to a message received from the networked controller, said message including the prescribed time, and said prescribed time being a time at which an event notification indicator is set in another networked device that communicates with the networked controller.

19. The networked device of claim 18 wherein the actuator is a switch and the networked device is a coffee maker.

20. The networked device of claim 18 wherein the networked interface is a ZigBee interface.
